(19) United States
(12) Patent Application Publication
(10) Pub. No.: US 2026/0243949 A1
(43) Pub. Date: Aug. 20, 2026

(54) OPTICAL FIBER BUNDLE STRUCTURE, PROCESS FOR MANUFACTURING OPTICAL FIBER BUNDLE STRUCTURE, AND OPTICAL FIBER CONNECTION STRUCTURE

(71) Applicant: SUMITOMO ELECTRIC INDUSTRIES, LTD., Osaka (JP)

(72) Inventors: Osamu SHIMAKAWA, Osaka (JP); Hidehisa TAZAWA, Osaka (JP); Masato TANAKA, Osaka (JP)

(73) Assignee: SUMITOMO ELECTRIC INDUSTRIES, LTD., Osaka (JP)

(21) Appl. No.: 19/532,534

(22) Filed: Feb. 6, 2026

(30) Foreign Application Priority Data
Feb. 17, 2025 (JP) 2025-023747

(51) Int. Cl. G02B 6/04; G02B 6/02

(52) U.S. Cl. CPC G02B 6/04; G02B 6/02004

(57) ABSTRACT

An optical fiber bundle structure according to one embodiment includes a plurality of single-core fibers; and a ferrule having a holding hole into which the plurality of single-core fibers are inserted. Each of the plurality of single-core fibers includes an MFD-expanded portion, which is a portion in which a mode field diameter is expanded, at a distal end portion of each of the single-core fibers. A cladding of each of the single-core fibers in the MFD-expanded portion is thinner than the cladding of each of the single-core fibers in portions other than the MFD-expanded portion. At least two of a plurality of the MFD-expanded portions are in contact with each other in the holding hole.

### CROSS REFERENCE TO RELATED APPLICATIONS

This application claims priority based on Japanese Patent Application No. 2025-023747 filed on Feb. 17, 2025, and the entire contents of the Japanese patent application are incorporated herein by reference.

### TECHNICAL FIELD

The present disclosure relates to an optical fiber bundle structure, a process for manufacturing an optical fiber bundle structure, and an optical fiber connection structure.

### BACKGROUND

International Publication No. WO 2022/004220 describes an optical fiber bundle structure. The optical fiber bundle structure includes a multi-core fiber; a plurality of single-core fibers; a first lens having a focal length f1 (mm); and a second lens having a focal length f2 (mm). The disposition of the center position of each core in a cross-section perpendicular to a longitudinal direction of the multi-core fiber and the disposition of the center position of each core in a cross-section perpendicular to a longitudinal direction of the plurality of single-core fibers have a similar shape. When the pitch of the cores of the multi-core fiber is defined as P1 (μm), the mode field diameter of a first end face of each core is defined as MFD1 (μm), the pitch of the cores of the plurality of single-core fibers is defined as P2 (μm), and the mode field diameter of light at a second end face of each core is defined as MFD2 (μm), (P1/P2)×0.9≤f1/f2≤(P1/P2)×1.1 and (P1/P2)×0.9≤MFD1/MFD2≤(P1/P2)×1.1 are satisfied.

### SUMMARY

An optical fiber bundle structure according to the present disclosure includes a plurality of single-core fibers; and a ferrule having a holding hole into which the plurality of single-core fibers are inserted. Each of the plurality of single-core fibers includes an MFD-expanded portion, which is a portion in which a mode field diameter is expanded, at a distal end portion of each of the single-core fibers. A cladding of each of the single-core fibers in the MFD-expanded portion is thinner than the cladding of each of the single-core fibers in portions other than the MFD-expanded portion. At least two of a plurality of the MFD-expanded portions are in contact with each other in the holding hole.

### BRIEF DESCRIPTION OF THE DRAWINGS

FIG. 1 is a view showing an optical fiber connection structure according to an embodiment.

FIG. 2 is a cross-sectional view showing an optical fiber bundle structure according to an embodiment.

FIG. 3 is a view showing a step of a process for manufacturing an optical fiber bundle structure according to an embodiment.

FIG. 4 is a view showing a step of the process for manufacturing an optical fiber bundle structure according to the embodiment.

FIG. 5 is a view showing a step of the process for manufacturing an optical fiber bundle structure according to the embodiment.

FIG. 6 is a view showing a state in which an MFD-expanded portion is enlarged.

FIG. 7 is a view showing a step of the process for manufacturing an optical fiber bundle structure.

FIG. 8 is a view showing optical fiber bundle structure according to a modification example.

FIG. 9 is a view showing a step of a process for manufacturing an optical fiber bundle structure according to a modification example.

FIG. 10 is a view showing a step of the process for manufacturing an optical fiber bundle structure according to the modification example.

FIG. 11 is a view showing a step of the process for manufacturing an optical fiber bundle structure according to the modification example.

FIG. 12 is a cross-sectional view showing an optical fiber bundle structure according to a modification example.

### DETAILED DESCRIPTION

In the optical fiber bundle structure, the plurality of single-core fibers are inserted into a holding hole of a ferrule. In order to allow the plurality of single-core fibers to be inserted into the holding hole, the inner diameter of the holding hole may be made larger. In this case, gaps may be formed between the plurality of single-core fibers in the holding hole. When gaps are formed between the plurality of single-core fibers, the pitch of the single-core fibers becomes larger than a design value, and a decrease in optical coupling efficiency may occur.

An object of the present disclosure is to provide an optical fiber bundle structure, a process for manufacturing an optical fiber bundle structure, and an optical fiber connection structure capable of enhancing optical coupling efficiency.

According to the present disclosure, the optical coupling efficiency can be enhanced.

First, an embodiment of an optical fiber bundle structure, a process for manufacturing an optical fiber bundle structure, and an optical fiber connection structure according to the present disclosure will be listed and described. (1) The optical fiber bundle structure according to the present embodiment includes a plurality of single-core fibers; and a ferrule having a holding hole into which the plurality of single-core fibers are inserted. Each of the plurality of single-core fibers includes an MFD-expanded portion, which is a portion in which a mode field diameter is expanded, at a distal end portion of each of the single-core fibers. A cladding of each of the single-core fibers in the MFD-expanded portion is thinner than the cladding of each of the single-core fibers in portions other than the MFD-expanded portion. At least two of a plurality of the MFD-expanded portions are in contact with each other in the holding hole.

In the optical fiber bundle structure, each of the plurality of single-core fibers inserted into the holding hole of the ferrule includes the MFD-expanded portion that is a portion in which the MFD is expanded. The MFD-expanded portion is formed at the distal end portion of each of the single-core fibers. The cladding of a portion in which the MFD-expanded portion is formed is thinner than the cladding of portions in which the MFD-expanded portion is not formed, and the plurality of MFD-expanded portions are in contact with each other in the holding hole. By bringing at least two of the plurality of MFD-expanded portions into contact with each other in the holding hole, gaps between the plurality of single-core fibers in the holding hole can be reduced. Therefore, since the pitch of the single-core fibers can be prevented from becoming larger than a design value, the optical coupling efficiency can be enhanced.

(2) In (1) above, a difference between a cladding diameter of each of the single-core fibers in the portions other than the MFD-expanded portion and a cladding diameter of each of the single-core fibers in the MFD-expanded portion may be 5 μm or less. In this case, the cladding in the MFD-expanded portion can be prevented from becoming too thinner.

(3) In (1) or (2) above, each of the plurality of MFD-expanded portions may be in contact with at least one of the plurality of MFD-expanded portions.

(4) A process for manufacturing an optical fiber bundle structure according to the present embodiment includes a step of forming an MFD-expanded portion, which is a portion in which a mode field diameter is expanded and a cladding is thinned, in a single-core fiber by heating the single-core fiber; a step of cutting the MFD-expanded portion; and a step of inserting the MFD-expanded portions of a plurality of the single-core fibers, which are obtained by cutting the MFD-expanded portion, into a holding hole of a ferrule, and disposing the plurality of single-core fibers in the holding hole such that directions in which a plurality of the MFD-expanded portions are slightly curved approach each other.

In the manufacturing process, the MFD-expanded portion is formed by heating the single-core fiber, and the plurality of single-core fibers including the MFD-expanded portions are obtained by cutting the MFD-expanded portion. The MFD-expanded portion formed by heating and cutting are slightly curved, and the plurality of MFD-expanded portions are inserted into the holding hole of the ferrule. The plurality of single-core fibers are disposed in the holding hole such that the directions in which the plurality of MFD-expanded portions are slightly curved approach each other. Since the directions in which the plurality of MFD-expanded portions are slightly curved are set to approach each other, the plurality of MFD-expanded portions in the holding hole come into contact with each other. Therefore, since the gaps between the plurality of single-core fibers in the holding hole can be reduced, the optical coupling efficiency can be enhanced.

(5) In (4) above, the manufacturing process may further include a step of reducing a diameter of the MFD-expanded portions after the step of cutting the MFD-expanded portion and before the step of disposing the plurality of single-core fibers. In this case, by reducing the diameter of the MFD-expanded portions, the optical coupling efficiency can be further enhanced.

(6) In (5) above, in the step of reducing the diameter, the diameter of the MFD-expanded portions may be reduced by subjecting the MFD-expanded portions to chemical etching. In this case, a reduction in the diameter of the MFD-expanded portions can be easily performed.

(7) An optical fiber connection structure according to the present embodiment includes a multi-core fiber; the optical fiber bundle structure described above; a first lens facing a first end face that is a distal end face of the multi-core fiber; and a second lens disposed between second end faces, which are distal end faces of the plurality of single-core fibers of the optical fiber bundle structure, and the first lens. The same effects as those of the optical fiber bundle structure described above are obtained from the optical fiber connection structure.

Specific examples of an optical fiber bundle structure, a process for manufacturing an optical fiber bundle structure, and an optical fiber connection structure of the present disclosure will be described below with reference to the drawings. The present invention is not limited to each example which will be described later, but is defined by the claims, and it is intended that all modifications within the scope equivalent to the claims are included. In the description of the drawings, the same or corresponding elements are denoted by the same reference signs, and redundant descriptions are omitted as appropriate. The drawings are depicted in a partially simplified or exaggerated manner for ease of understanding, and the dimensional ratios are not limited to those shown in the drawings.

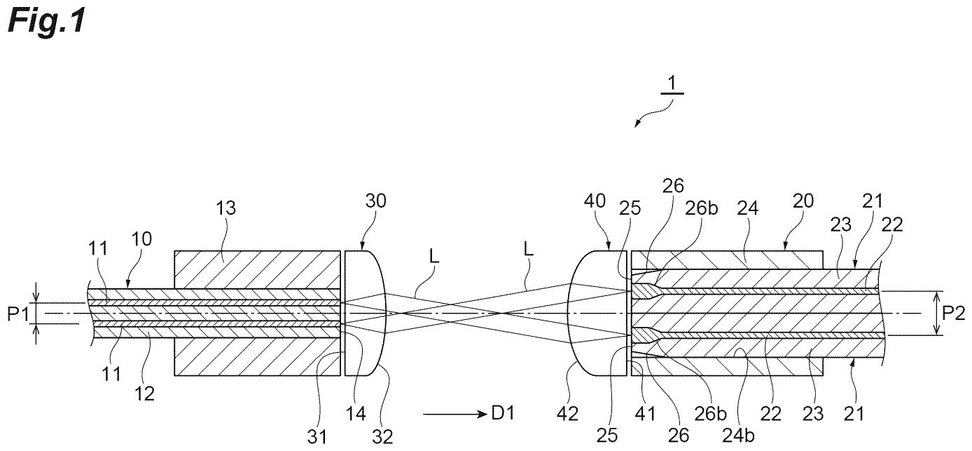

FIG. 1 is a view showing an optical fiber connection structure 1 according to an embodiment. The optical fiber connection structure 1 is, for example, a lens-coupled multi-core fiber fan-in/fan-out (FIFO) device. Hereinafter, the multi-core fiber and the single-core fiber will be described as MCF and SCF, respectively. The optical fiber connection structure 1 includes an MCF 10; an optical fiber bundle structure 20; a first lens 30 interposed between the MCF 10 and the optical fiber bundle structure 20; and a second lens 40 interposed between the optical fiber bundle structure 20 and the first lens 30.

The MCF 10 includes a plurality of (for example, two) cores 11 and a cladding 12. The MCF 10 is held by a ferrule 13. The optical fiber bundle structure 20 includes, for example, two SCFs 21. Each of the SCFs 21 includes a core 22 and a cladding 23. The optical fiber connection structure 1 is a fan-in/fan-out device that separates a light L, which passes through the MCF 10, into a plurality of the SCFs 21, or that couples the light L, which passes through each of the plurality of SCFs 21, into one MCF 10. The light L is, for example, light having a wavelength in the 1.55 μm band.

The optical fiber connection structure 1 may be used, for example, in an optical amplifier that splits the light L, which passes through each of the cores 11 of the MCF 10, toward each of the plurality of SCFs 21, and amqplifies each of the split lights L. The optical fiber connection structure 1 may be used in an optical transmitter that transmits the light L from each of the plurality of SCFs 21, or an optical receiver that receives the light L from each of the plurality of SCFs 21.

In the optical fiber connection structure 1, the MCF 10, the first lens 30, the second lens 40, and the optical fiber bundle structure 20 are disposed so as to be aligned in this order along an optical axis direction D1 that is a direction in which the optical axes of the SCFs 21 extend. The MCF 10 and the SCFs 21 are optically coupled to each other through a space (spatially coupled).

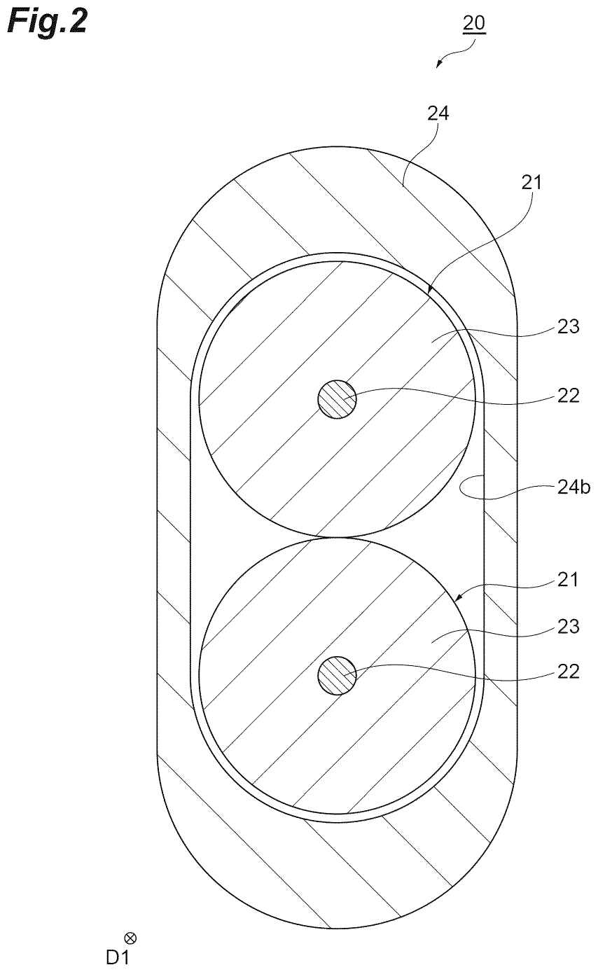

FIG. 2 is a cross-sectional view of the optical fiber bundle structure 20 obtained by cutting the optical fiber bundle structure 20 with a plane perpendicular to the optical axis direction D1. As shown in FIGS. 1 and 2, the plurality of SCFs 21 are bundled in the ferrule 24. The ferrule 24 has a holding hole 24b into which the plurality of SCFs 21 are inserted. As one example, the ferrule 24 is filled with the two SCFs 21.

In a cross-section cut along a plane perpendicular to the optical axis direction D1, the disposition shape of a plurality of the cores 22 of the SCFs 21 and the disposition shape of the plurality of cores 11 of the MCF 10 are similar to each other. When the pitch (center-to-center distance) of the cores 11 of the MCF 10 is defined as P1 (μm), and the pitch of the cores 22 of the SCFs 21 is defines as P2 (μm), P2 is larger than P1. For example, P2 coincides with the diameter of each of the SCFs 21 (claddings 23).

When the mode field diameter of the light L having a specific wavelength at the output end face of the cores 11 of the MCF 10 is defined as MFD1 (μm), and the mode field diameter of the light L having the same specific wavelength at the output end face of the cores 22 of the SCFs 21 is defined as MFD2 (μm), MFD2 is larger than MFD1. Hereinafter, the “mode field diameter” may be referred to as MFD. P1, P2, MFD1, and MFD2 satisfy the following Equation (1).

$$( P 1 / P 2 ) \times 0.9 \leq MFD 1 / MFD 2 \leq ( P 1 / P 2 ) \times 1.1 \qquad ( 1 )$$

The MCF 10 has a first end face 14 facing the first lens 30. The SCFs 21 have second end faces 25 facing the second lens 40. For example, both the first lens 30 and the second lens 40 are rod lenses. The first lens 30 has, for example, a flat surface 31 facing the MCF 10, and a curved surface 32 opposite to the flat surface 31. The second lens 40 has, for example, a flat surface 41 facing the plurality of SCFs 21, and a curved surface 42 opposite to the flat surface 41. When the focal length of the first lens 30 is defined as f1 (mm), and the focal length of the second lens 40 is defined as f2 (mm), for example, f2 is larger than f1. P1 and P2 described above, f1, and f2 satisfy the following Equation (2).

$$( P 1 / P 2 ) \times 0.9 \leq f 1 / f 2 \leq ( P 1 / P 2 ) \times 1.1 \qquad ( 2 )$$

For example, each of the SCFs 21 is a thermally expanded core (TEC) fiber. The SCF 21 includes an MFD-expanded portion 26, which is a portion in which the MFD is expanded, at a distal end portion of the SCF 21. For example, the MFD-expanded portion 26 includes a core-expanded portion 26b that is a portion in which the core 22 is expanded in a tapered shape. Since the core 22 is expanded at the distal end portion of the SCF 21, the MFD of the light L that has propagated through the SCF 21 increases in the core-expanded portion 26b in a direction perpendicular to the optical axis direction D1.

A plurality of the MFD-expanded portions 26 are in contact with each other in the holding hole 24b. The cladding 23 of each of the SCFs 21 in the MFD-expanded portion 26 is thinner than the cladding 23 of each of the SCFs 21 in portions other than the MFD-expanded portion 26. The difference between the cladding diameter of each of the SCFs 21 in portions other than the MFD-expanded portion 26 and the cladding diameter of each of the SCFs 21 in the MFD-expanded portion 26 is, for example, 0.5 μm or more 5 μm or less.

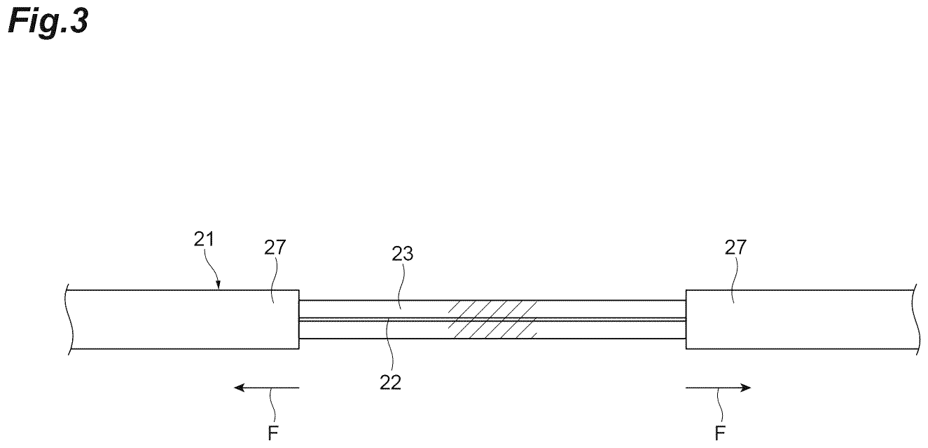

A process for manufacturing an optical fiber bundle structure according to the present embodiment will be described. Hereinafter, a process for manufacturing the optical fiber bundle structure 20 described above will be described. In FIGS. 3 to 7 and FIGS. 9 to 11, hatching is omitted for ease of understanding. As shown in FIG. 3, the SCF 21 is prepared, and a part of a coating 27 of the SCF 21 is removed to expose the cladding 23. For example, a tension F is applied to a portion of the SCF 21 in which the cladding 23 is exposed. The tensile force of F is, as one example, 30 g or less.

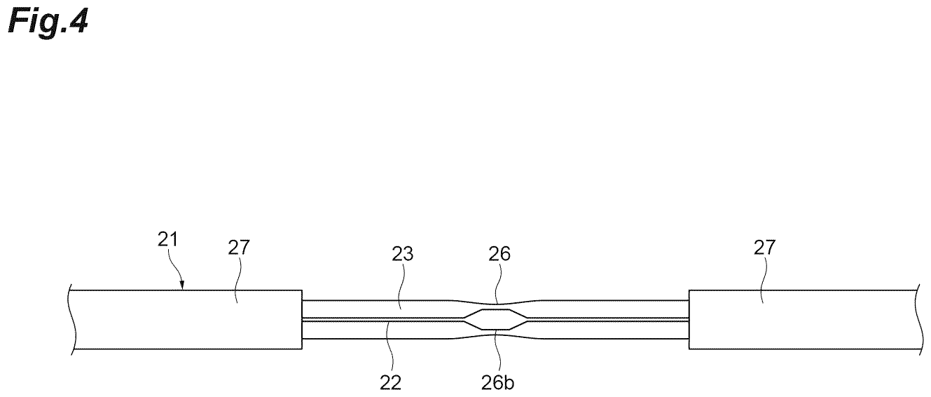

The portion of the SCF 21 in which the cladding 23 is exposed is heated in a state in which the tension F is applied as described above. In FIG. 3, the portion to be heated are indicated by diagonal lines. As shown in FIGS. 3 and 4, when the portion of the SCF 21 in which the cladding 23 is exposed is heated, the MFD expands due to diffusion of germanium, which is a dopant of the core 22, in the portion. Due to this heating, the heated portion elongates and becomes thinner. For example, when the outer diameter of the cladding 23 is 125 μm, the outer diameter of the heated portion of the cladding 23 is 122 μm or more and 124 μm or less. In this way, by heating the SCF 21, the MFD-expanded portion 26 that is a portion in which the MFD is expanded and the cladding 23 is thinned is formed in the SCF 21 (a step of forming the MFD-expanded portion).

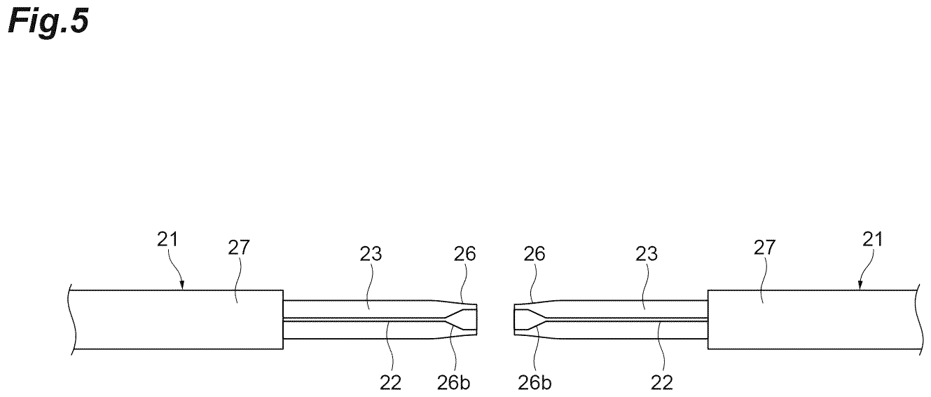

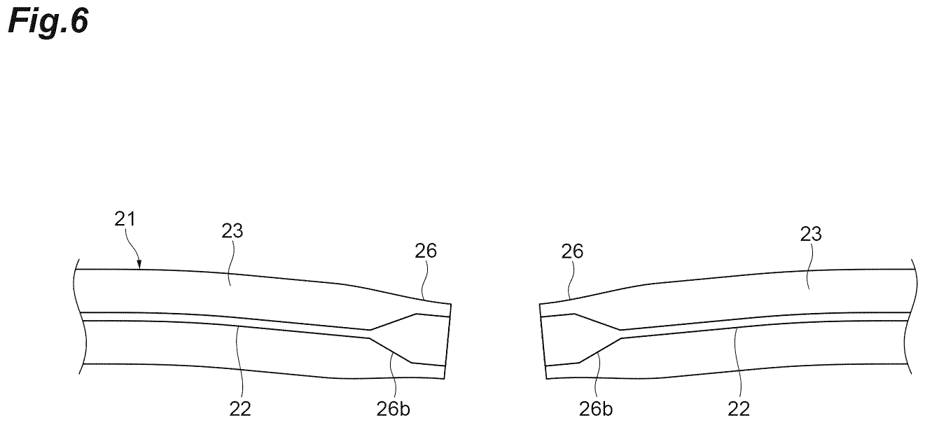

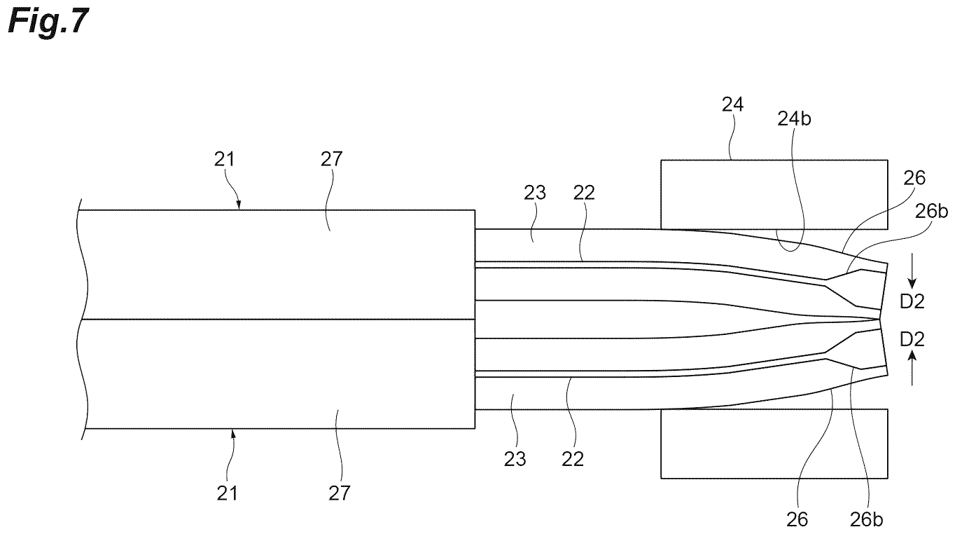

As shown in FIGS. 5 and 6, the MFD-expanded portion 26 is cut (a step of cutting the MFD-expanded portion). The heated and cut MFD-expanded portion 26 is slightly curved. For example, the heated and cut MFD-expanded portion 26 deflects downward due to gravity. As shown in FIG. 7, the MFD-expanded portions 26 of the plurality of SCFs 21 obtained by heating are inserted into the holding hole 24b of the ferrule 24. The plurality of SCFs 21 are disposed in the holding hole 24b such that directions D2 in which the plurality of MFD-expanded portions 26 are slightly curved approach each other (a step of disposing). The plurality of MFD-expanded portions 26 are brought into contact with each other in the holding hole 24b. After the holding hole 24b in which the plurality of SCFs 21 are disposed is filled with an adhesive and the plurality of SCFs 21 are fixed to the holding hole 24b, the series of steps of the process for manufacturing the optical fiber bundle structure 20 are completed.

The effects obtained from the optical fiber connection structure 1, the optical fiber bundle structure 20, and the process for manufacturing an optical fiber bundle structure according to the present embodiment will be described. In the optical fiber connection structure 1 and the optical fiber bundle structure 20, each of the plurality of SCFs 21 inserted into the holding hole 24b of the ferrule 24 includes the MFD-expanded portion 26 that is a portion in which the MFD is expanded. The MFD-expanded portion 26 is formed at the distal end portion of the SCF 21. The cladding 23 of a portion of each of the SCFs 21 in which the MFD-expanded portion 26 is formed is thinner than the cladding 23 of portions in which the MFD-expanded portion 26 is not formed, and the plurality of MFD-expanded portions 26 are in contact with each other in the holding hole 24b. At least two of the plurality of MFD-expanded portions 26 are in contact with each other in the holding hole 24b. By bringing at least two of the plurality of MFD-expanded portions 26 into contact with each other in the holding hole 24b, gaps between the plurality of SCFs 21 in the holding hole 24b can be reduced. Therefore, since the pitch of the SCFs 21 can be prevented from becoming larger than the design value, the optical coupling efficiency can be enhanced. Each of the plurality of MFD-expanded portions 26 may be in contact with at least one of the plurality of MFD-expanded portions 26.

The difference between the cladding diameter of each of the SCFs 21 in the portions other than the MFD-expanded portion 26 and the cladding diameter of each of the SCFs 21 in the MFD-expanded portion 26 may be 5 μm or less. In this case, the cladding 23 in the MFD-expanded portion 26 can be prevented from becoming too thinner.

In the process for manufacturing an optical fiber bundle structure according to the present embodiment, the MFD-expanded portion 26 is formed by heating the SCF 21, and the plurality of SCFs 21 including the MFD-expanded portions 26 are obtained by cutting the MFD-expanded portion 26. The MFD-expanded portions 26 formed by heating and cutting are slightly curved, and the plurality of MFD-expanded portions 26 are inserted into the holding hole 24b of the ferrule 24. The plurality of SCFs 21 are disposed in the holding hole 24b such that the directions D2 in which the plurality of MFD-expanded portions 26 are slightly curved approach each other. Since the directions D2 in which the plurality of MFD-expanded portions 26 are slightly curved are set to approach each other, the plurality of MFD-expanded portions 26 in the holding hole 24b come into contact with each other. Therefore, since the gaps between the plurality of SCFs 21 in the holding hole 24b can be reduced, the optical coupling efficiency can be enhanced.

Hereinafter, an optical fiber connection structure, an optical fiber bundle structure, and a process for manufacturing an optical fiber bundle structure according to a modification example will be described. A part of the optical fiber connection structure, the optical fiber bundle structure, and the process for manufacturing an optical fiber bundle structure according to the modification example is the same as a part of the optical fiber connection structure 1, the optical fiber bundle structure 20, and the process for manufacturing an optical fiber bundle structure described above. Hereinafter, the same configurations as those in the contents that have already been described are denoted by the same reference signs, and the descriptions are omitted as appropriate.

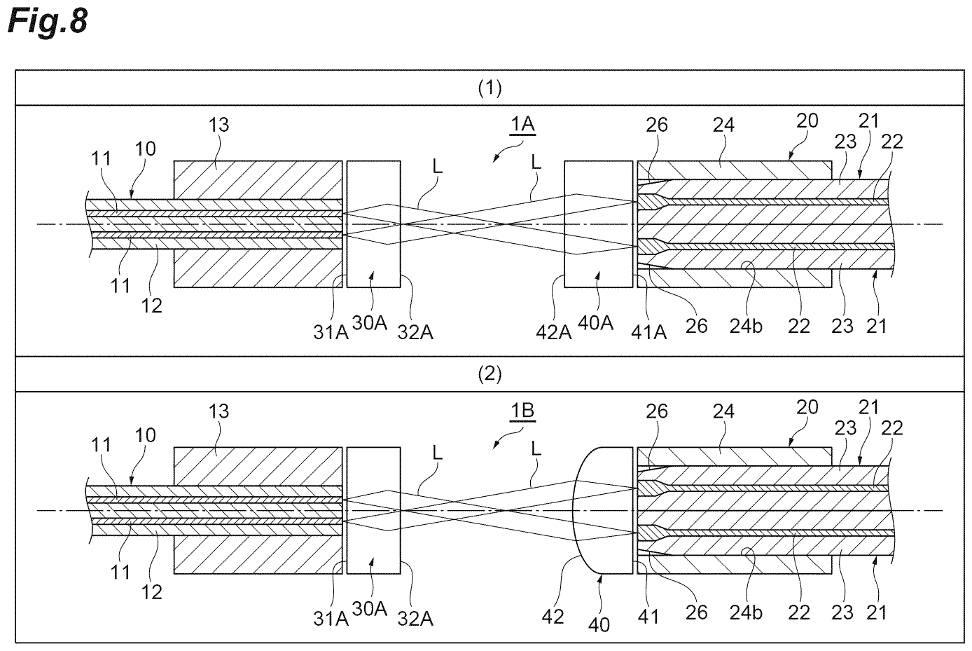

FIG. 8 is a view showing optical fiber connection structure 1A and 1B according to a modification example. As shown in (1) of FIG. 8, the optical fiber connection structures 1A include a first lens 30A and a second lens 40A different from the first lens 30 and the second lens 40 described above, and the first lens 30A and the second lens 40, respectively. The first lens 30A has a flat surface 31A facing the MCF 10, and a flat surface 32A opposite to the flat surface 31A. The second lens 40A has a flat surface 41A facing the plurality of SCFs 21, and a flat surface 42A opposite to the flat surface 41A. As shown in (2) of FIG. 8, the optical fiber connection structure 1B includes the first lens 30A and the second lens 40 described above. In this way, various lenses can be used as the first lens and the second lens. Each of the first lens and the second lens may be a spherical lens, a GRIN lens, or an aspherical lens, each of which has a rod shape.

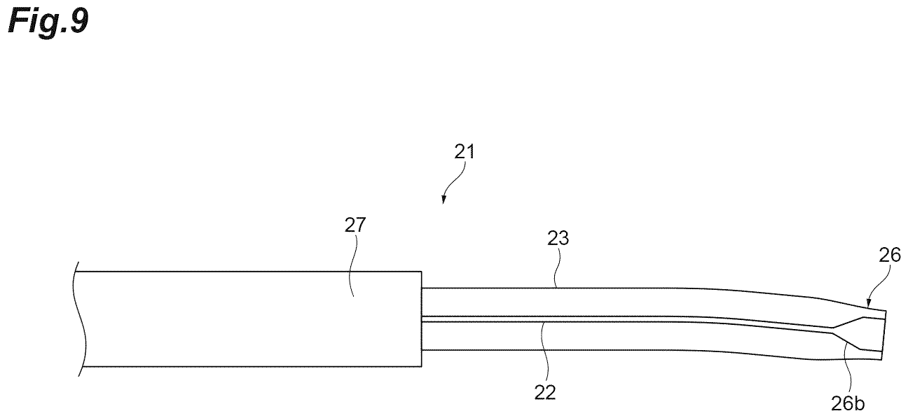

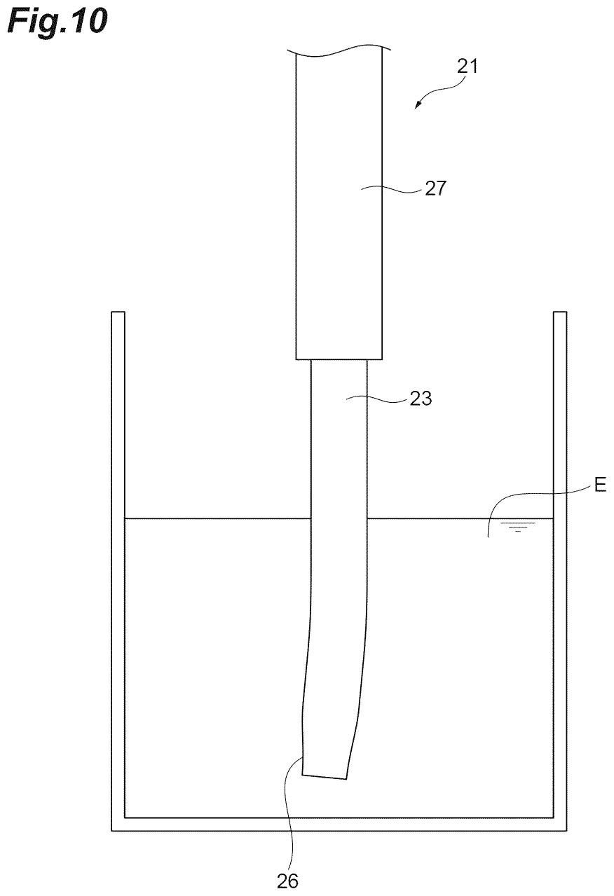

A process for manufacturing an optical fiber bundle structure according to a modification example will be described. As shown in FIGS. 9 and 10, by executing the step of cutting the MFD-expanded portion 26 and then performing chemical etching on the MFD-expanded portions 26, the diameter of the MFD-expanded portions 26 is reduced (a step of reducing the diameter of the MFD-expanded portions). For example, etching is performed by applying a chemical solution E to the MFD-expanded portions 26. The chemical solution E is, for example, a buffered hydrofluoric acid solution or a hydrofluoric acid solution.

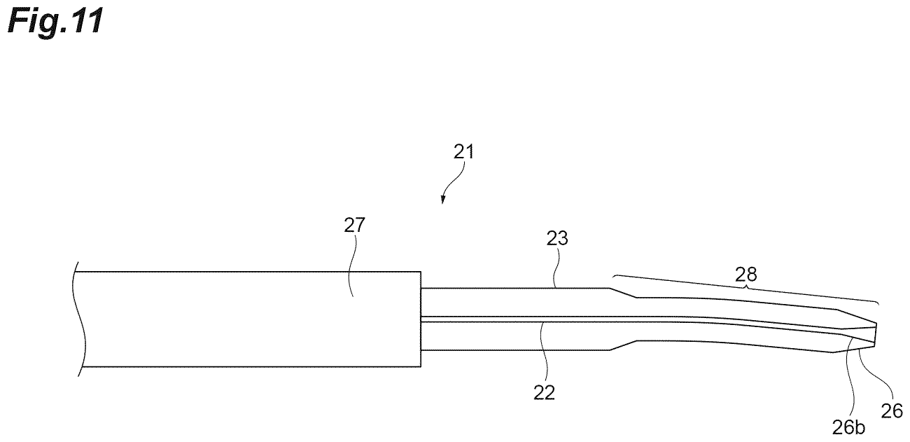

As shown in FIG. 11, by performing the above-described chemical etching, a diameter-reduced portion 28 including the MFD-expanded portion 26 is formed at the distal end portion of the SCF 21. For example, the outer diameter of the diameter-reduced portion 28 in portions other than the MFD-expanded portion 26 is 120 μm, and the outer diameter of the diameter-reduced portion 28 in the MFD-expanded portion 26 is 115 μm or more and 120 μm or less. After the step of reducing the diameter of the MFD-expanded portions 26, similarly to the manufacturing process described above, the plurality of SCFs 21 are disposed in the holding hole 24b such that the directions D2 in which the plurality of MFD-expanded portions 26 are slightly curved approach each other (a step of disposing). Thereafter, the series of steps are completed.

As described above, the process for manufacturing an optical fiber bundle structure according to the modification example includes the step of reducing the diameter of the MFD-expanded portions 26 after the step of cutting the MFD-expanded portion 26 and before the step of disposing the plurality of SCFs 21. In this case, by reducing the diameter of the MFD-expanded portions 26, the optical coupling efficiency can be further enhanced. More specifically, since the magnification of the first lens 30 and the second lens 40 can be decreased by reducing the diameter of the MFD-expanded portions 26, the coupling efficiency of the light L can be enhanced by reducing distortion aberration by lenses. In the step of reducing the diameter, the diameter of the MFD-expanded portions 26 may be reduced by subjecting the MFD-expanded portions 26 to chemical etching. In this case, a reduction in the diameter of the MFD-expanded portions 26 can be easily performed.

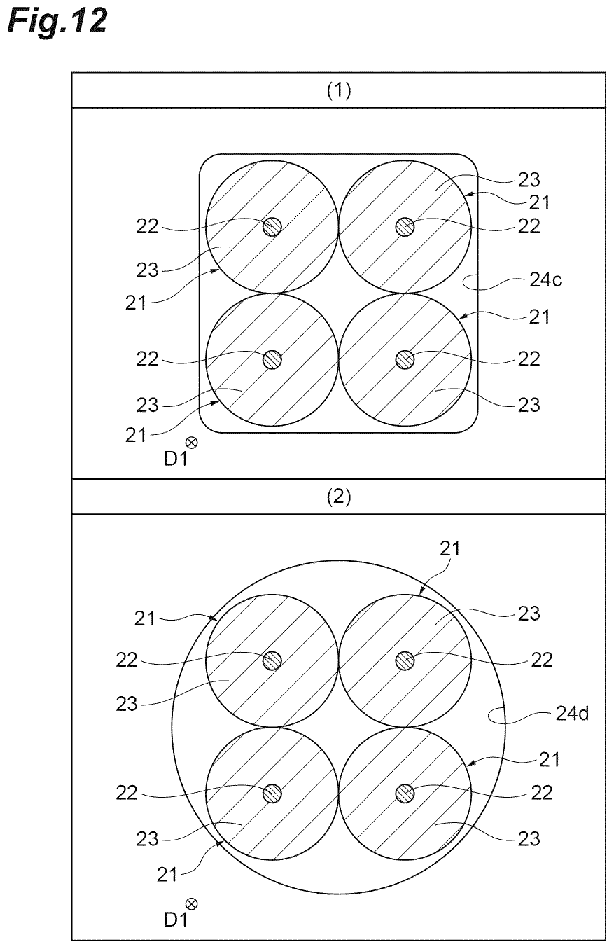

FIG. 12 is a cross-sectional view showing optical fiber bundle structure according to a modification example. In the optical fiber bundle structure according to the modification example, the number of the SCFs 21 and the shape of the holding hole of the ferrule 24 are different from those in the embodiment described above. As shown in FIG. 12, the optical fiber bundle structures may include four SCFs 21. As shown in (1) of FIG. 12, a cross-section of a holding hole 24c of the ferrule of the optical fiber bundle structure taken perpendicular to the optical axis direction D1 has a quadrilateral shape. As shown in (2) of FIG. 12, a cross-section of a holding hole 24d of the ferrule of the optical fiber bundle structure taken perpendicular to the optical axis direction D1 may have a circular shape. In this way, in the optical fiber bundle structure, the number of the SCFs and the shape of the cross-section of the holding hole can be changed as appropriate.

The embodiment and various modification examples of the optical fiber bundle structure, the process for manufacturing an optical fiber bundle structure, and the optical fiber connection structure according to the present disclosure have been described. However, the optical fiber bundle structure, the process for manufacturing an optical fiber bundle structure, and the optical fiber connection structure according to the present disclosure are not limited to the embodiment and the modification examples described above, and may be further modified within the scope of the concept described in the claims. The shape, size, material, number, and disposition mode of each part of the optical fiber bundle structure and the optical fiber connection structure according to the present disclosure and the contents and order of the steps of the process for manufacturing an optical fiber bundle structure can be changed within the scope of the claims. For example, in the embodiment described above, in the process for manufacturing an optical fiber bundle structure, an example in which the tension F is applied to the portion of the SCF 21 in which the cladding 23 is exposed has been described. However, the tension F may not be applied to the portion of the SCF 21 in which the cladding 23 is exposed.

### Reference Sings List

1, 1A, 1B Optical fiber connection structure
10 Multi-core fiber (MCF)
11 Core
12 Cladding
13 Ferrule
14 First end face
20 Optical fiber bundle structure
21 Single-core fiber (SCF)
22 Core
23 Cladding
24 Ferrule
24b, 24c, 24d Holding hole
25 Second end face
26 MFD-expanded portion
26b Core-expanded portion
27 Coating
28 Diameter-reduced portion
30, 30A First lens
31, 31A Flat surface
32 Curved surface
32A Flat surface
40, 40A Second lens
41, 41A Flat surface
42 Curved surface
42A Flat surface
E Chemical solution

What is claimed is:

1. An optical fiber bundle structure comprising:
a plurality of single-core fibers; and
a ferrule having a holding hole into which the plurality of single-core fibers are inserted,
wherein each of the plurality of single-core fibers includes an MFD-expanded portion, which is a portion in which a mode field diameter is expanded, at a distal end portion of each of the single-core fibers,
a cladding of each of the single-core fibers in the MFD-expanded portion is thinner than the cladding of each of the single-core fibers in portions other than the MFD-expanded portion, and
at least two of a plurality of the MFD-expanded portions are in contact with each other in the holding hole.

2. The optical fiber bundle structure according to claim 1,
wherein a difference between a cladding diameter of each of the single-core fibers in the portions other than the MFD-expanded portion and a cladding diameter of each of the single-core fibers in the MFD-expanded portion is 5 μm or less.

3. The optical fiber bundle structure according to claim 1,
wherein each of the plurality of MFD-expanded portions is in contact with at least one of the plurality of MFD-expanded portions.

4. A process for manufacturing an optical fiber bundle structure, comprising:
a step of forming an MFD-expanded portion, which is a portion in which a mode field diameter is expanded and a cladding is thinned, in a single-core fiber by heating the single-core fiber;
a step of cutting the MFD-expanded portion; and
a step of inserting the MFD-expanded portions of a plurality of the single-core fibers, which are obtained by cutting the MFD-expanded portion, into a holding hole of a ferrule, and disposing the plurality of single-core fibers in the holding hole such that directions in which a plurality of the MFD-expanded portions are curved approach each other.

5. The process for manufacturing an optical fiber bundle structure according to claim 4, further comprising:
a step of reducing a diameter of the MFD-expanded portions after the step of cutting the MFD-expanded portion and before the step of disposing the plurality of single-core fibers.

6. The process for manufacturing an optical fiber bundle structure according to claim 5,
wherein in the step of reducing the diameter, the diameter of the MFD-expanded portions are reduced by subjecting the MFD-expanded portions to chemical etching.

7. An optical fiber connection structure comprising:
a multi-core fiber;
the optical fiber bundle structure according to claim 1;
a first lens facing a first end face that is a distal end face of the multi-core fiber; and
a second lens disposed between second end faces, which are distal end faces of the plurality of single-core fibers of the optical fiber bundle structure, and the first lens.
